(19) United States
(12) Patent Application Publication
(10) Pub. No.: US 2023/0104786 A1
(43) Pub. Date: Apr. 6, 2023

(54) TIME ZONE TRANSLATION PLATFORM

(71) Applicant: Citrix Systems, Inc., Fort Lauderdale, FL (US)

(72) Inventors: Shutian Yao, Nanjing (CN); Ke Xu, Nanjing (CN); Zongpeng Qiao, Nanjing (CN)

(21) Appl. No.: 17/499,015

(22) Filed: Oct. 12, 2021

Related U.S. Application Data
(63) Continuation of application No. PCT/CN2021/121554, filed on Sep. 29, 2021.

(51) Int. Cl. H04L 12/58; H04L 29/08

(52) U.S. Cl. CPC H04L 51/063; H04L 67/18; H04W 4/14

(57) ABSTRACT

A system and method for translating among time zones in text-based messages. A disclosed method includes: receiving a text-based message sent from a first device to a second device; detecting whether the text-based message includes a specified time; in response to detecting that the text-based message includes the specified time: calculating a translated time that converts the specified time from a first time zone associated with the first device to a second time zone associated with the second device; and packaging the translated time with the text-based message, wherein the translated time is viewable by a user of the second device via a visual indictor; and forwarding the text-based message with the translated time to the second device.

### BACKGROUND OF THE DISCLOSURE

Text-based messages allow users around the world to efficiently interact with each other. Text-based communication platforms, such as SMS, email, messenger apps, chat, collaborative applications, etc., are often used to plan or schedule events, such as online meetings, conference calls, etc. In one typical scenario, users will exchange messages proposing and counter-proposing dates and times until agreement is reached.

### BRIEF DESCRIPTION OF THE DISCLOSURE

Aspects of this disclosure include a system and method that detects when a text-based message is being sent with a specified time. If a specified time is detected, the time is translated from a time zone of the sender to a time zone of each intended recipient. The message is then delivered to each recipient and displayed with a visual indicator that allows the recipient to view a translated time.

A first aspect of the disclosure provides a computing device that includes a memory storing instructions for processing text-based messages and a processor coupled to the memory and configured to execute the instructions to perform processes. The processes include receiving a text-based message sent from a first user to a second user and detecting whether the text-based message includes a specified time. In response to detecting that the text-based message includes the specified time: calculating a translated time that converts the specified time from a first time zone associated with the first user to a second time zone associated with the second user; and packaging the translated time with the text message, wherein the translated is viewable by the second user. Finally, forwarding the text message with the translated time to the second user.

A second aspect of the disclosure provides a method of processing text-based messages that includes receiving a text-based message sent from a first device to a second device and detecting whether the text-based message includes a specified time. In response to detecting that the text-based message includes the specified time: calculating a translated time that converts the specified time from a first time zone associated with the first device to a second time zone associated with the second device; and packaging the translated time with the text-based message, wherein the translated time is viewable by a user of the second device via a visual indictor. Finally, forwarding the text-based message with the translated time to the second device.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative workspace environment configured to provide time zone translations, in accordance with an illustrative embodiment.

FIG. 2 depicts a first view of a client workspace, in accordance with an illustrative embodiment.

FIG. 3 depicts a second view of a client workspace, in accordance with an illustrative embodiment.

FIG. 4 depicts a chat interface for a first user, in accordance with an illustrative embodiment.

FIG. 5 depicts a chat interface for a second user, in accordance with an illustrative embodiment.

FIG. 6 depicts a chat interface for a third user, in accordance with an illustrative embodiment.

FIG. 7 depicts a translation sequence diagram, in accordance with an illustrative embodiment.

FIG. 8 depicts a network infrastructure, in accordance with an illustrative embodiment.

FIG. 9 depicts a computing system, in accordance with an illustrative embodiment.

FIG. 10A is a block diagram of an example system in which resource management services may manage and streamline access by clients to resource feeds (via one or more gateway services) and/or software-as-a-service (SaaS) applications.

FIG. 10B is a block diagram showing an example implementation of the system shown in FIG. 10A in which various resource management services as well as a gateway service are located within a cloud computing environment.

FIG. 10C is a block diagram similar to that shown in FIG. 10B but in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for processing text-based messages that include a specified time. In current practice, when text-based messages are communicated among users in different time zones (e.g., to scheduled meetings, etc.), recipients of messages that include a specified time must manually convert the specified time to a translated time in their own time zone. This practice is both time consuming and subject to mistakes. To address this issue, a time zone translation platform is provided that automatically detects when a text-based message is being communicated among users with a specified time. If a specified time is detected, the time is automatically translated from a time zone of the sender to a time zone of each intended recipient. The message is then delivered to each recipient with a visual indicator that the recipient can interact with to view the translated time.

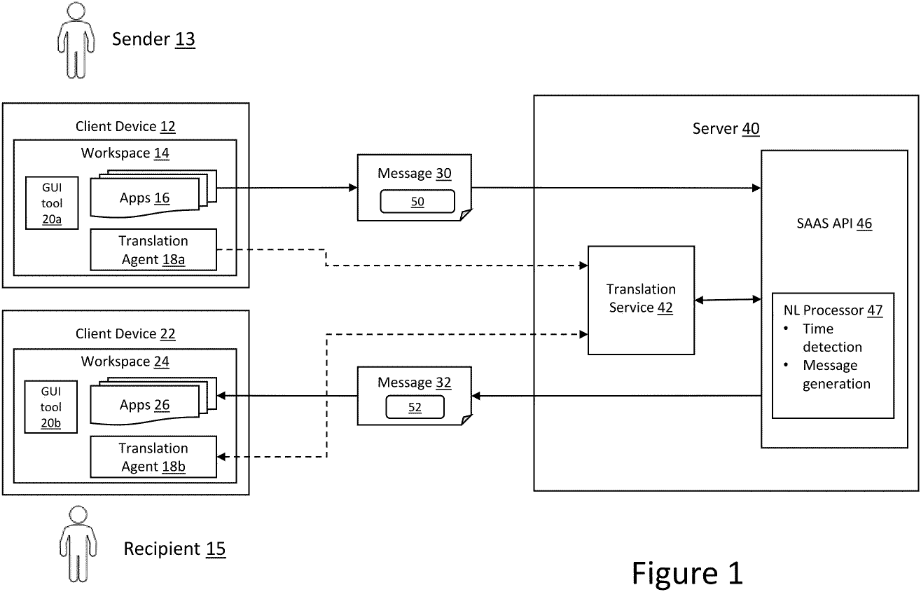

In one illustrative embodiment, the time zone translation platform is implemented in a virtual workspace environment, such as that shown in FIG. 1. Illustrative virtual workspace environments include CITRIX® Workspace, available from Citrix System, Inc. of Fort Lauderdale, Florida, which provides an information retrieval service where users can access programs and files from a variety of sources through a central application or a Web browser. In the example shown, a set of client devices 12, 22 each include a virtual workspace 14, 24, respectively, which interact with a server 40 such as a cloud server. Each workspace 14, 24 includes one or more applications (Apps) 16, 26, respectively that provide messaging capabilities, i.e., the ability to communicate text-based messages to other users within the workspace platform. Illustrative Apps 16, 26 that provide messaging may for example include SMS Apps, email Apps, social media Apps, Web-based chat windows, business and personal communication Apps, collaborative applications, etc.

In the depicted embodiment, each workspace 14, 24 is equipped with: (1) a translation agent 18a,b that is used to determine location information of a workspace user; and (2) a graphical user interface (GUI) tool 20a,b that is utilized by the user to view time zone translation information in received messages. Server 40 is responsible for managing the workspaces 14, 24 and further includes: (1) a translation service 42 that converts a specified time to one more translated times based on the time zones of the users; and (2) a software as a service (SAAS) application programming interface (API) 46 that intercepts text-based messages and determines if the message includes a specified time. If a message 30 includes a specified time, SAAS API 46 obtains a translated time from the translation service 42 based on the locations of the sender 13 and the recipient 15 and repackages a new message 32 with a translated time payload 52 that includes a translated time for the recipient. Payload 52 may also include an indicator that determines where a specified time resides with the message 32 (e.g., the 4^{th} word in the message). In still a further embodiment, payload 52 may include a visual indicator (such as a highlighting feature) that will display with the specified time in the message 32. Regardless, once generated, the repackaged message 32 is forwarded to the associated App in the workspace 24 of the recipient 15, where the recipient can use GUI tool 20 to interact with the message to view the translated time. In some cases, the GUI tool 20 may use the indicator in message 32 to highlight the specified time when the message is displayed. In other cases, the GUI tool 20 may simply display a visual indicator received with the message. Thus, for example, if the original message 30 from the sender 13 originated in the US Eastern time zone and included a specified time of 3PM, and the recipient 15 was in the US Pacific time zone, the repackaged message would include a translated time of 12PM. GUI tool 20b would highlight the specified time 3PM in the original message and include a mechanism for viewing the translated time of 12PM.

In the depicted embodiment, the location data 50 of the sender 13 is packaged with the original message 30. Location data 50 may be obtained in manner, e.g., from the translation agent 18a running on workspace 14, directly from the client device 12 itself, etc. Location data 50 may be determined each time a new message is sent or when the sender activates the workspace 14 in the same manner as the recipient 15. In still a further case, rather than including the location information 50 with the message 30, location information 50 could be communicated by the translation agent 18a to, and stored with, the translation service 42 either when the workspace 14 is activated or when the message is sent. In the case where the location information 50 is obtained when the workspace is activated by either/both the sender 13 and recipient 15, the location information 50 may be updated periodically to account for mobile client devices whose locations/time zones could change. Additionally, it is noted that location information 50 may include any type of location data, e.g., GPS coordinates, a city name, a time zone, etc.

In an illustrative example, when a first user of client device 22 (i.e., recipient 15) launches workspace 24, the first user can interact with the translation agent 18b within the workspace 24 to specify the location of the first user. This information is then provided by the translation agent 18b to the translation service 42 on the server 40. Thereafter, when a second user (i.e., a sender 13) sends a message 30 from and App 16 on client device 12 to the recipient 15, the message 30 with the location information 50 of the sender is routed through server 40. At the server 40, the message 30 is intercepted and processed by SAAS API 46. Once intercepted, SAAS API 46 determines if the message 30 includes a specified time. If a specified time is included, SAAS API 46 engages translation service 42 to translate the specified time into a translated time based on sender’s and recipient’s locations.

In one illustrative embodiment, a natural language (NL) processor 47 is utilized to detect and extract time information from the message 30 and to generate a translated time message string (i.e., translated time) for the repackaged message 32. In some instance, this may include detecting and generating both a date value and time value (referred to collectively herein as a “time”). For instance, if the sent message 30 said “can we talk next Wednesday May 8 at 11 PM,” the translated time may occur on the following day, e.g., “Thursday May 9 at 8 AM.” Accordingly, NL processor 47 can be equipped to determine and report both a translated time value (i.e., 8 AM) and a translated date value (i.e., Thursday May 9). In further cases, the NL processor may be equipped to process terms such as “today,” “tomorrow,” “tomorrow morning,” etc., to help detect a specified time and generate the translated time. Regardless, once the translated time is calculated, the message 32 is repackaged with a payload 52 that includes the translated time and optionally an indicator (or visual indicator) of where the specified time resides in the message. Once generated, the message 32 is forwarded to the associated App 26 for the recipient 15 at client device 22. Once received, the recipient 15 can use the GUI tool 20b to interact with the message (e.g., via a visual indicator) to view the translated time.

In an alternative embodiment, as certain types of messages are limited in size and capabilities, rather than including payload 52 in message 32, payload 52 could be obtained separately, e.g., directly from the translation service 42 via the translation agent 18b in workspace 24, via a separate message, etc.

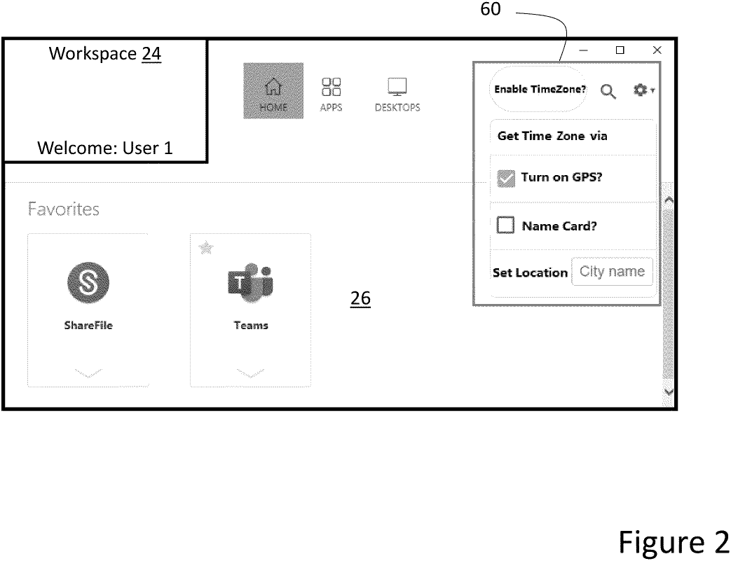

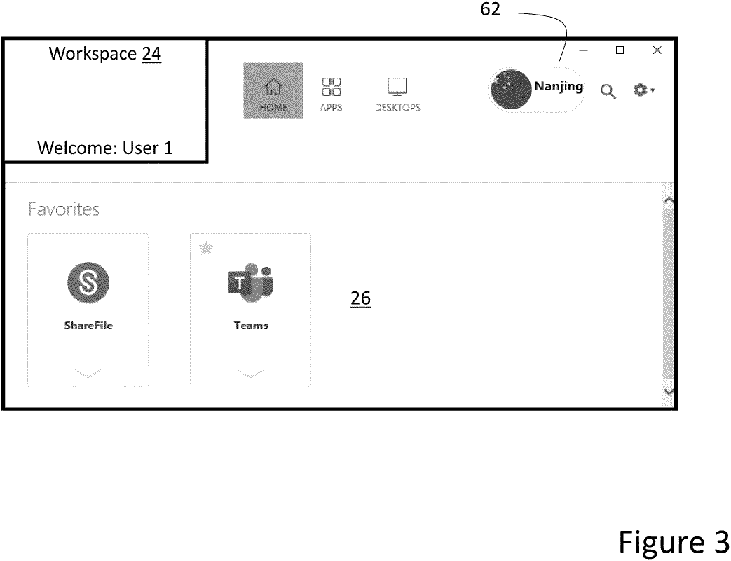

FIG. 2 depicts an illustrative workspace 24 of the recipient user that includes a set of Apps 26 and a dropdown window 60 for enabling time zone translation. In this example, the user can enable time zone translation by activating GPS, by using a look-up service (such as selecting a name card) that stores the location of the user, or by simply entering a location. Once enabled, the location of the user 62 is displayed as shown in FIG. 3 (i.e., Nanjing) and is made available to translation agent 18b (FIG. 1).

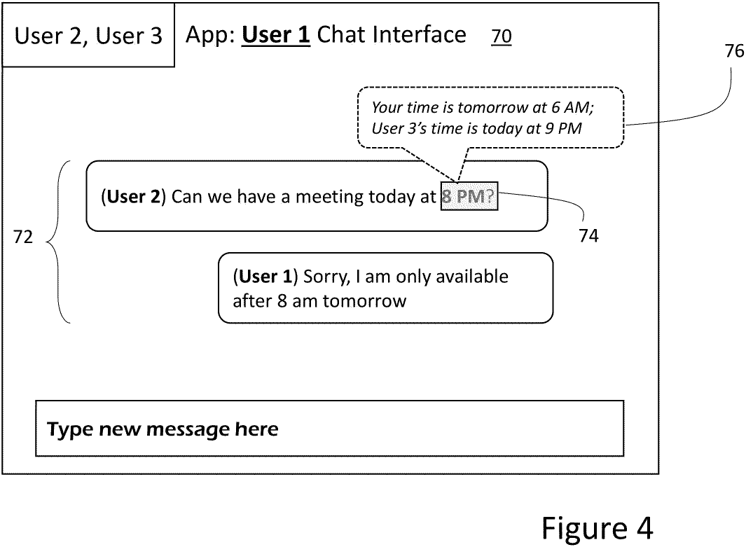

FIGS. 4-6 depict an illustrative chat exchange among three users, User 1, User 2 and User 3. FIG. 4 shows User 1’s chat interface 70 containing two messages 72, including an initial message from User 2 and a response from User 1. As shown, User 2 sent the initial message, “Can we have a meeting today at 8 PM?” that includes a specified time, i.e., 8 PM. The specified time is displayed with a visual indicator 74 that alters an appearance of the original message, in this case the specified time is highlighted in box. User 1 is then able to interact with the visual indicator 74 to view translated time details, e.g., move or hover their mouse pointer or cursor onto the highlighted region of the visual indicator 74 to display an overlay balloon 76. Because there are three users, the overlay balloon 76 includes both User 1’s translated time (i.e., “Your time is tomorrow at 6AM”) and User 3’s translated time (i.e., “User 3’s time is today at 9 PM”). Accordingly, User 1 is able to quickly translate User 2’s specified time of 8 PM into the time zones of User 1 and User 3. In this example, User 1 responds with “Sorry, I am only available after 8 am tomorrow”.

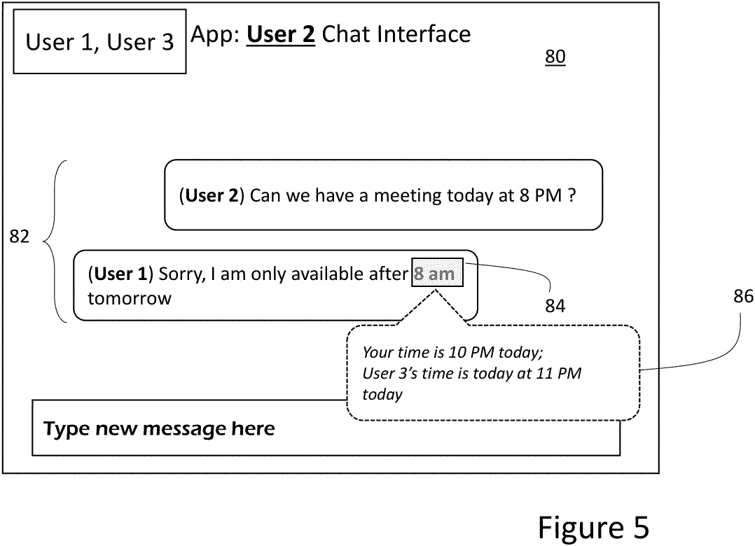

FIG. 5 shows the same exchange 82 on User 2’s chat interface 80. As shown, User 2 is able to select the visual indicator 84 in User 1’s response that includes the specified time of 8 AM. When selected, translated times for User 2 and User 3 are displayed in overlay balloon 86. Namely, User 2’s translated time for 8 AM is provided as “Your time is 10 PM today” and User 3’s translated time is provided as “User 3’s time is today at 11 PM today.”

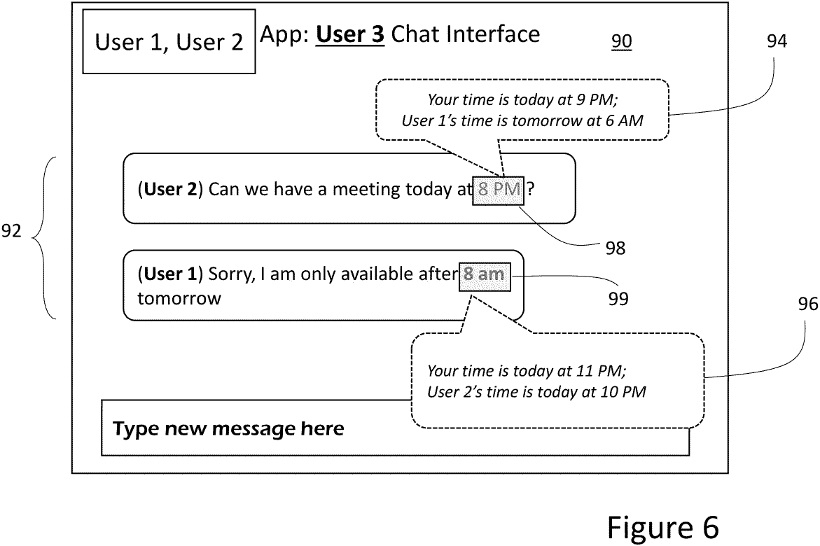

FIG. 6 shows the same exchange 92 on User 3’s chat interface 90. As shown, User 3 is able to select either visual indicator 98 or 99 in both the original message from User 2 and the response from User 1. As shown, when User 3 selects visual indicator 98, User 2’s specified time is translated and displayed in overlay balloon 94 for User 3 (“Your time is today at 9 PM”), and User 1 (“User 1’s time is tomorrow at 6 AM”). Alternatively, when User 3 selects visual indicator 99 in User 1’s response, User 1’s specified time is translated and displayed in overlay balloon 96 for User 3 (“Your time is today at 11 PM”), and User 2 (“User 2’s time is tomorrow at 10 PM”).

Note that the visual indicators and overlay balloons for showing translated times in FIGS. 4-6 are provided for illustrative purposes only, and any other GUI elements could alternatively be used. For instance, visual indicators could use underlining, colorization, blinking text, etc. Translated times could, e.g., be overlaid onto the specified time, appear in a dropdown box, be output as audio, etc.

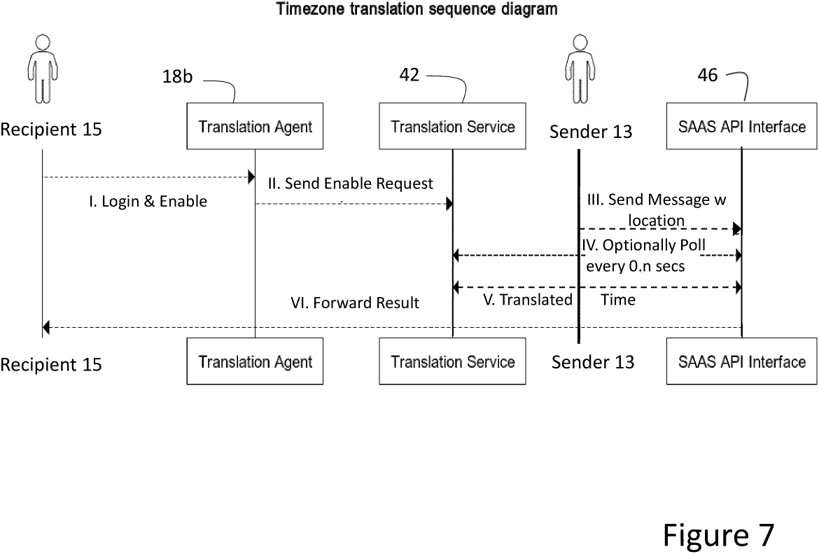

FIG. 7 depicts an illustrative time zone translation sequence diagram. Initially, at stage I, the recipient 15 logs into their workspace and enables time zone translation, which causes the translation agent 18b to send an enable request (including the recipient’s location) to the translation service 42 at stage II. At stage III, the sender 13 sends a message to the recipient 15 via a respective App, which gets intercepted by the SAAS API 46. At stage IV, SAAS API 46 determines if a specified time exists in the message. This may include a polling operation that examines messages, e.g., in a message queue on the server, that determines if a specified time is detected. Depending on the implementation, a mechanism to automatically trigger the translation service 42 may or may not be provided. In the case where such a mechanism is not provided, a background polling operation may be deployed to periodically check messages in a message queue (e.g., every 0.5 seconds) to determine if a translated in required. Assuming a specified time is detected, then at stage V a translated time is calculated and returned to the SAAS API 46. At stage VI, the translated time is forwarded to the recipient 15 via the recipient’s App.

As noted, SAAS API 46 may include a natural language (NL) processor 47 to detect a specified time and generate a translated time message string. In one illustrative embodiment, time information from a message is detected using a combination of open-source algorithms, Word2vec and CRF (Conditional Random Fields). In this illustrative approach:
1. Each word of a message is converted into n-dimension (e.g., 300-dimension) vectors using pre-trained word vectors (Such as that provided at: https://code.google.com/archive/p/word2vec/).
2. Each word’s 300-dimension vectors are used as the CRF algorithm input, and the output of the algorithm is a characteristic or property of this outputted word, e.g., if the word involves a time value, the output will include a “TT” indicator. Because this CRF model already exists, the algorithm leverages the pre-trained model to calculate whether words belong to “TT” or not.
3. When a time is detected (6:30 PM), the time value is processed with a filter by the algorithm combination, and stored in a structured time format (e.g., 18:30:00).

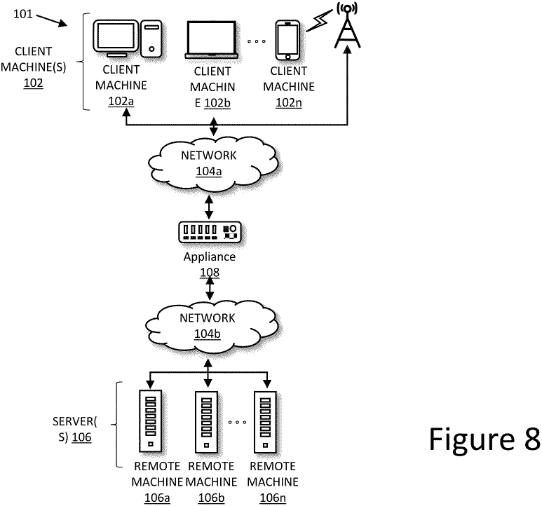

Referring to FIG. 8, a non-limiting network environment 101 in which various aspects of the disclosure may be implemented includes one or more client machines 102A-102N, one or more remote machines 106A-106N, one or more networks 104, 104’, and one or more appliances 108 installed within the computing environment 101. The client machines 102A-102N communicate with the remote machines 106A-106N via the networks 104, 104’.

In some embodiments, the client machines 102A-102N communicate with the remote machines 106A-106N via an intermediary appliance 108. The illustrated appliance 108 is positioned between the networks 104, 104’ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104’.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104’ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

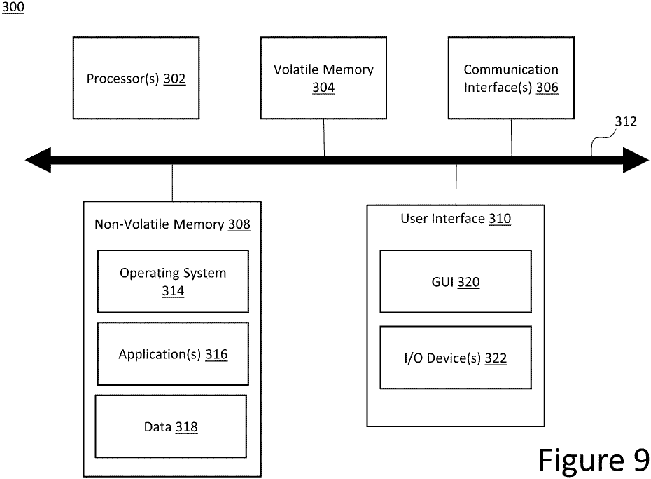

Elements of the described solution may be embodied in a computing system, such as that shown in FIG. 9 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 9 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

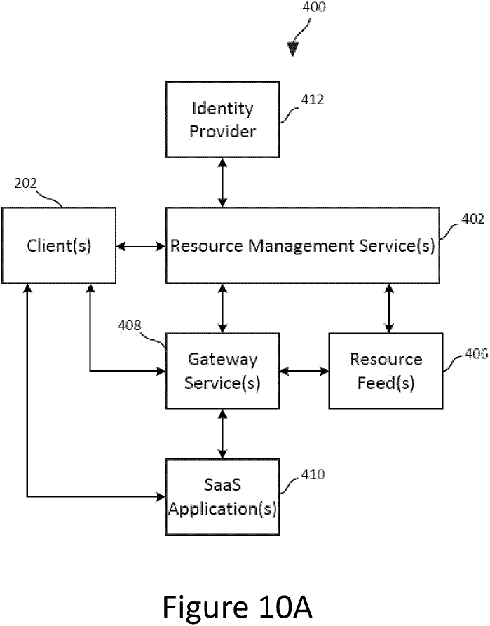

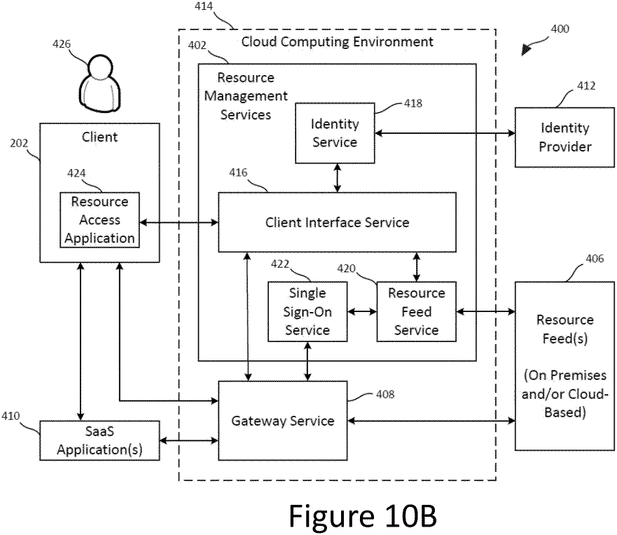

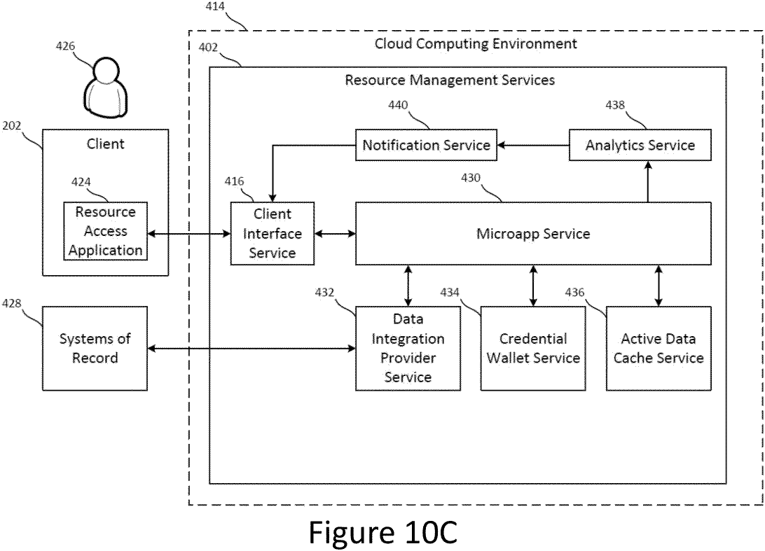

FIG. 10A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 10B is a block diagram showing an example implementation of the system 400 shown in FIG. 10A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 10B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 10B) on the client 202.

As explained in more detail below, in some embodiments, the resource access application 424 and associated components may provide the user 426 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 8B), as described above. Upon receiving a sign-on request, the identity service 418 may cause the resource access application 424 (via the client interface service 416) to prompt the user 426 for the user’s authentication credentials (e.g., user-name and password). Upon receiving the user’s authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user’s identity has been properly authenticated, the client interface service 416 may send a request to the resource feed service 420 for a list of subscribed resources for the user 426.

In other embodiments (not illustrated in FIG. 10B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user’s authentication credentials. Upon determining the user’s identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user’s identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user’s attention (e.g., approval of an expense report, new course available for registration, etc.).

FIG. 10C is a block diagram similar to that shown in FIG. 8B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 8C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 10C may be employed either in addition to or instead of the different services shown in FIG. 10B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 10C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 10C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user’s actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith’s phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they’re looking for.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/- 10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A computing device, comprising:
a memory storing instructions for processing text-based messages; and
a processor coupled to the memory and configured to execute the instructions to perform processes including:
receiving a text-based message sent from a first user to a plurality of users ;
detecting whether the text-based message includes a specified time;
in response to detecting that the text-based message includes the specified time:
calculating a set of translated times that convert the specified time from a first time zone associated with the first user to a plurality of time zones associated with the plurality of users; and
packaging the translated times with the text message, wherein the translated times is are viewable by the plurality of users and
forwarding the text message with the translated times to the plurality of users .

2. The computing device of claim 1, wherein the text-based message is communicated between applications within a virtual workspace platform.

3. The computing device of claim 2, wherein the text-based message is communicated within one of a chat window, a social media platform, an SMS application, an email application, a communication application or a collaborative application.

4. The computing device of claim 2, wherein the translated times are viewable via a visual indicator that alters an appearance of the specified time for each of the plurality of users in the text-based message when viewed by any of the plurality of users in a graphical user interface (GUI).

5. The computing device of claim 4, wherein, in response to one of the plurality of users selecting the visual indicator in the GUI, displaying the translated times for each of the other plurality of users in the GUI.

6. The computing device of claim 5, wherein the visual indicator appears as a highlighted region and the selecting comprises hovering a cursor over the highlighted region.

7. The computing device of claim 2, further comprising:
obtaining a second time zone of the a second user of the plurality of users in response to the second user enabling a time zone translation feature in a workspace; and
storing the second time zone of the second user.

8. The computing device of claim 7, further comprising: receiving location information of the first user with the text-based message.

9. The computing device of claim 1, wherein detecting whether the text-based message includes the specified time comprises:
converting each word in the text message into an n-dimensional vector; and
analyzing each n-dimensional vector with a model to determine if the word contains a time value.

10. The computing device of claim 9, wherein the model comprises a pre-trained conditional random fields (CRF) model.

11. A method of processing text-based messages between a first device and a second device, comprising:
receiving location information indicative of a time zone from the second device in response to a workspace on the second device being activated in a virtual workspace platform;
receiving a text-based message sent from the first device to the second device;
detecting whether the text-based message includes a specified time;
in response to detecting that the text-based message includes the specified time:
calculating a translated time that converts the specified time from a first time zone associated with the first device to the time zone associated with the second device; and
packaging the translated time with the text-based message, wherein the translated time is viewable by a user of the second device via a visual indictor; and
forwarding the text-based message with the translated time to the second device.

12. The method of claim 11, further comprising receiving first location information indicative of the first time zone from the first device in response to a first workspace on the first device being activated in the virtual workspace platform.

13. The method of claim 12, wherein the text-based message is communicated within one of a chat window, an SMS application, a social media platform, an email application, a communication application, or a collaborative application.

14. The method of claim 12, wherein the visual indicator alters an appearance of the specified time in the text-based message when viewed by the user in a graphical user interface (GUI) on the second device.

15. The method of claim 14, wherein, in response to the user selecting the visual indicator in the virtual application, displaying the translated time in the GUI.

16. The method of claim 15, wherein the visual indicator appears as a highlighted region and the selecting comprises hovering a cursor over the highlighted region.

17. The method of claim 12, further comprising:
obtaining the location information of the second device in response to a user enabling a time zone translation feature in the second workspace; and
storing the time zone of the second device.

18. The method of claim 17, further comprising: receiving location information of the first device with the text-based message.

19. The method of claim 11, wherein detecting whether the text-based message includes the specified time comprises:
converting each word in the text-based message into an n-dimensional vector; and
analyzing each n-dimensional vector with a model to determine if the word contains a time value.

20. The method of claim 19, wherein the model comprises a pre-trained conditional random fields (CRF) model.
